(19) United States
(12) Patent Application Publication
(10) Pub. No.: US 2010/0157129 A1
(43) Pub. Date: Jun. 24, 2010

(54) APPARATUS AND METHOD FOR CAPTURING DIGITAL IMAGE USING FACE RECOGNITION FUNCTION

(75) Inventor: Jae-sun Lee, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/616,191

(22) Filed: Nov. 11, 2009

(30) Foreign Application Priority Data
Dec. 24, 2008 (KR) 10-2008-0133794

(51) Int. Cl. G06K 9/46; H04N 5/222

(52) U.S. Cl. 348/333.04; 382/203; 348/E05.022

(57) ABSTRACT

Provided are an apparatus and method for capturing a digital image including two or more faces by using a face recognition function that aids in preventing overlap in the faces or a significant difference in the sizes of the faces. The apparatus for capturing a digital image by using a face recognition function comprises a digital signal processing means for guiding changing of a capturing composition when face recognition regions are adjacent or overlap with each other or when the sizes of face recognition regions differ from each other.

### CROSS-REFERENCE TO RELATED PATENT APPLICATION

This application claims the benefit of Korean Patent Application No. 10-2008-0133794, filed on Dec. 24, 2008, in the Korean Intellectual Property Office, the disclosure of which is incorporated herein in its entirety by reference.

### BACKGROUND OF THE INVENTION

1. Field of the Invention

The present invention relates to an apparatus and method for capturing a digital image including two or more faces by using a face recognition function so that at least some of the faces in the image do not overlap with each other and to prevent a significant difference in the sizes of two or more faces in the image.

2. Description of the Related Art

In general, a digital capturing device includes a face recognition function and thus, recognizes a plurality of faces of subjects and provides a capturing function by focusing on the subjects.

### SUMMARY OF THE INVENTION

One or more embodiments of the present invention provide an apparatus or method for capturing a digital image by using a face recognition function so that two or more faces in the image do not overlap with each other. In addition, one or more embodiments of the present invention provide a face recognition function to prevent a significant difference in the sizes of two or more faces when capturing a plurality of faces.

According to an embodiment of the present invention, there is provided an apparatus for capturing a digital image by using a face recognition function, the apparatus including: a digital signal processing means for guiding changing of a capturing composition when face recognition regions are adjacent or overlap with each other.

The digital signal processing means may automatically capture an image after a predetermined time, when the capturing composition is changed and the face recognition regions are not adjacent or do not overlap with each other.

The digital signal processing means may include: a face recognition unit recognizing faces in an image; a face recognition region display unit displaying the face recognition regions on the recognized faces; an adjacency/overlap determination unit determining whether the face recognition regions are adjacent or overlap with each other; and a composition change guiding unit guiding changing of a capturing composition when the face recognition regions are adjacent or overlap with each other.

The adjacency/overlap determination unit may calculate coordinate information about the face recognition regions, compare the coordinate information of an arbitrary face recognition region with the coordinate information of a face recognition region close to the arbitrary face recognition region, and thus, determine adjacency or overlap.

The composition change guiding unit may guide changing of the capturing composition by separately displaying adjacent or overlapping face recognition regions or by generating a text, sound or voice warning.

According to an embodiment of the present invention, there is provided an apparatus for capturing a digital image by using a face recognition function, the apparatus including: a digital signal processing means for guiding changing of a capturing composition when sizes of face recognition regions differ from each other.

The digital signal processing means may automatically capture an image after a predetermined time, when the capturing composition is changed and the sizes of the face recognition regions do not differ from each other.

The digital signal processing means includes: a face recognition unit recognizing faces in an image; a face recognition region display unit displaying the face recognition regions on the recognized faces; a size determination unit determining the sizes of the face recognition regions; and a composition change guiding unit guiding changing of a capturing composition when the face recognition regions are adjacent or overlap with each other.

The size determination unit may calculate the sizes of the face recognition regions from coordinate information about the face recognition regions, compare the sizes of the face recognition regions, and determine which face recognition region is larger.

The composition change guiding unit may guide changing of the capturing composition by separately displaying a larger face recognition region or by generating a text, sound or voice warning.

According to an embodiment of the present invention, there is provided a method of capturing a digital image by using a face recognition function, the method including: (a) recognizing faces in an image and displaying face recognition regions on the recognized faces; (b) determining whether the face recognition regions are adjacent or overlap; and (c) guiding changing of a capturing composition when the face recognition regions are adjacent or overlap with each other.

The method may further include (d) automatically capturing an image after a predetermined time, when the capturing composition is changed and the sizes of the face recognition regions do not differ from each other.

Step (b) of the method may further include: (b-1) calculating coordinate information about the face recognition regions; (b-2) calculating the sizes of the face recognition regions from the coordinate information; and (b-3) comparing the sizes of the face recognition regions and determining which of two or more face recognition regions is larger.

In (c), the capturing composition may be guided be changed by separately displaying a larger face recognition region or by generating a text, sound or voice warning.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for capturing a digital image by using a face recognition function according to an embodiment of the present invention;

FIG. 2 is a block diagram of a digital signal processor according to an embodiment that may be included in the apparatus of FIG. 1;

FIGS. 3A and 3B illustrate image capturing using the face recognition function described in relation to FIG. 2;

FIG. 4 is a block diagram of a digital signal processor according to another embodiment that may be included in the apparatus of FIG. 1;

FIGS. 5A and 5B illustrate image capturing using the face recognition function described in relation to FIG. 4;

FIG. 6 is a flowchart illustrating a method of capturing an image by using a face recognition function according to an embodiment of the present invention; and

FIG. 7 is a flowchart illustrating a method of capturing an image by using a face recognition function according to another embodiment of the present invention.

### DETAILED DESCRIPTION OF THE INVENTION

Hereinafter, the present invention will be described more fully with reference to the accompanying drawings in which exemplary embodiments of the invention are shown.

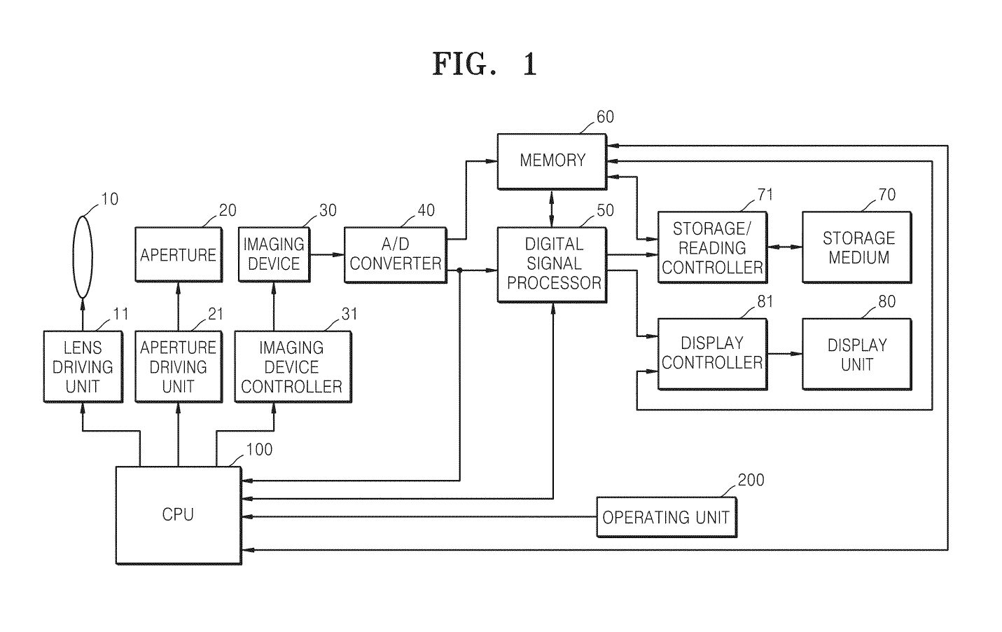

FIG. 1 is a block diagram of an apparatus for capturing a digital image by using a face recognition function according to an embodiment of the present invention. More specifically, FIG. 1 schematically illustrates an apparatus for capturing a digital image as a digital image processor. The present invention is not limited thereto and may be applied to image processors such as personal digital assistants (PDA) and personal multimedia players (PMP).

The operation of the apparatus for capturing a digital image is controlled by a central processing unit (CPU) 100. The apparatus for capturing a digital image includes an operating unit 200, which includes keys for generating electric signals from a user. The electric signals generated by the operating unit 200 are transmitted to the CPU 100 so that the CPU 100 may control the apparatus for capturing a digital image according to the electric signals.

In a capturing mode, when an electric signal is applied to the CPU 100 by the user, the CPU 100 identifies the electric signal and controls a lens driving unit 11, an aperture driving unit 21, and an imaging device controller 31. Accordingly, a position of a lens 10, an opening of an aperture 20, and sensitivity of an imaging device 30 are controlled. The imaging device 30 generates data from an input light and an analog/digital (AD) converter 40 converts analog data output from the imaging device 30 into digital data. The AD converter 40 is optional and may not be needed in an embodiment of an imaging device according to the present invention.

Data from the imaging device 30 may be input to a digital signal processor 50 through a memory 60 or may be input to the digital signal processor 50 without passing through the memory 60. The data from the imaging device 30 may be input to the CPU 100, as necessary. Here, the memory 60 may include read-only memory (ROM) or random access memory (RAM).

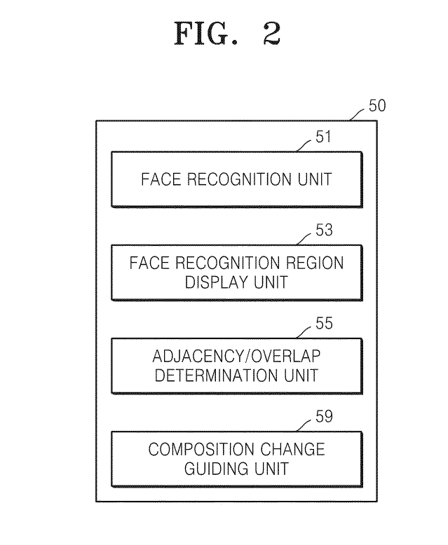

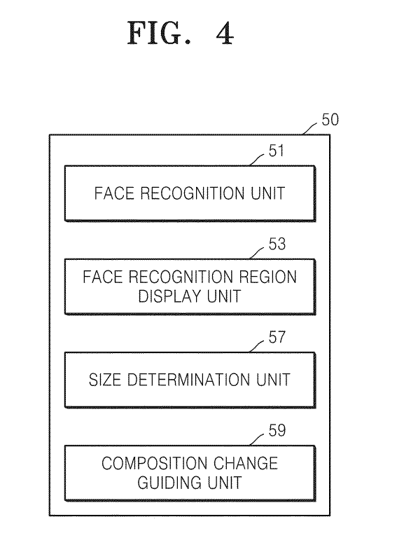

The digital signal processor 50 may perform digital signal processing such as gamma correction and white balance adjustment. In addition, as illustrated in FIGS. 2 and 4, the digital signal processor 50 may include a face recognition unit 51, a face recognition region display unit 53, an adjacency/overlap determination unit 55, a size determination unit 57, and a composition change guiding unit 59. In an embodiment, the adjacency/overlap determination unit is capable of determining if face regions are adjacent to each other, overlap with each other or both.

The face recognition unit 51, the face recognition region display unit 53, the adjacency/overlap determination unit 55, the size determination unit 57, and the composition change guiding unit 59 may be independent individual elements, instead of or apart from the elements included in the digital signal processor 50. In an embodiment, the digital signal processing means may include one or more processors that include one or more of the following: a face recognition unit, a face recognition region display unit, an adjacency/overlap determination unit, a size determination unit, a composition change guiding unit, a size determination unit and a composition change guiding unit.

The face recognition unit 51 recognizes faces from an image, the face recognition region display unit 53 displays face recognition regions on the recognized faces, the adjacency/overlap determination unit 55 determines whether the face recognition regions are adjacent or overlap with each other, the size determination unit 57 determines sizes of the face recognition regions, and the composition change guiding unit 59 guides changing of a capturing composition when the face recognition regions are adjacent or overlap with each other or guides changing of a capturing composition when the sizes of the face recognition regions are different. The operations of the face recognition unit 51, the face recognition region display unit 53, the adjacency/overlap determination unit 55, the size determination unit 57, and the composition change guiding unit 59 will be described later.

An image from data output from the digital signal processor 50 is transmitted to a display controller 81 through a memory 60 or directly transmitted to the display controller 81. The display controller 81 controls a display unit 80 and an image is displayed on the display unit 80. The data output from the digital signal processor 50 is input to a storage/reading controller 71 through the memory 60 or directly input to the storage/reading controller 71. The storage/reading controller 71 controls storage of image data in a storage medium 70 according to a signal from a user or automatically in the storage medium 70. The storage/reading controller 71 may control reading of data from the image file stored in the storage medium 70 and input the read data to the display controller 81 through the memory 60 or via some other route so that an image may be displayed on the display unit 80. The storage medium 70 may be removable or may be permanently equipped with a digital image processor.

Hereinafter, the operations of the face recognition unit 51, the face recognition region display unit 53, the adjacency/overlap determination unit 55, the size determination unit 57, and the composition change guiding unit 59 are described with reference to FIGS. 2-4.

FIG. 2 is a block diagram of the digital signal processor 50 according to an embodiment included in the apparatus for capturing a digital image using the face recognition function of FIG. 1. The digital signal processor 50 includes the face recognition unit 51, the face recognition region display unit 53, the adjacency/overlap determination unit 55, and the composition change guiding unit 59. The digital signal processor 50 of FIG. 2 guides changing of a capturing composition when face recognition regions are adjacent or overlap with each other when capturing an image including a group of faces.

The face recognition unit 51 detects at least one face from an image including a group of people. The face recognition unit 51 finds unchangeable features (facial elements such as eye, nose, and mouth, texture, and skin color) of a face by using a feature-based face detection method. In particular, the skin color from among various features of a face is less sensitive to movement or rotation of a face and a change of size and thus, is widely used. In an embodiment, one or more standard patterns with respect to a face are created using a face template based detection method and are stored in the face recognition unit 51 for face detection. Then, the patterns are compared with images one by one in a search window of the images and the face is detected. The most widely used face detection method is a support vector machine (SVM) based face detection method. SVM based methods are used to find a face from an input image after sub-sampling each different area from the image and learning a face (or a face portion) and a non-face (or a non-face portion). Details regarding detection of face information by using standard face recognition technology that are known to those of ordinary skill in the art will be omitted here.

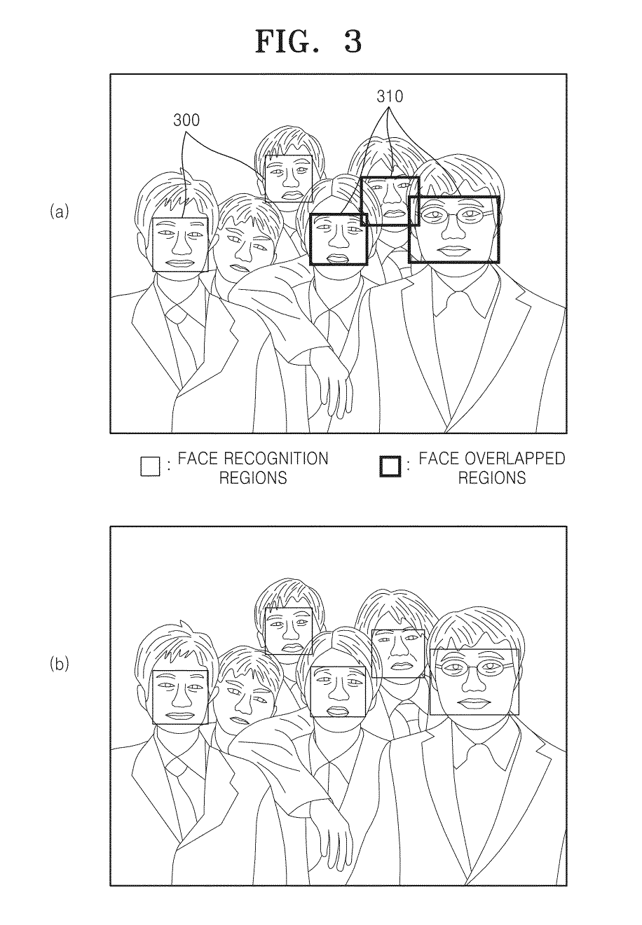

The face recognition region display unit 53 displays face recognition regions on the recognized faces. In the current face recognition method, a square recognition zone, that is, the face recognition region, is disposed over the face of each subject. The size of the face recognition region increases or decreases according to the distance between the subject and the lens 10. In FIG. 3A, the face recognition regions are displayed according to the result of face recognition for an image including a group of people.

The adjacency/overlap determination unit 55 calculates coordinate information about the face recognition regions, compares the coordinate information of an arbitrary face recognition region with the coordinate information of a face recognition region adjacent to the arbitrary face recognition region, thereby determining whether the regions are adjacent or overlap with each other. In another embodiment, whether the face recognition regions are adjacent or overlap with each other is determined in an orderly fashion, for example, starting from the left-most region and ending with the right-most region or starting from the region at the top and ending with the region at the bottom. Since the coordinate information about each face recognition region is determined or calculated, the coordinate information is used to determine adjacent face recognition regions or overlapping face recognition regions.

The composition change guiding unit 59 guides changing of a capturing composition when the face recognition regions are adjacent or overlap with each other by separately displaying adjacent or overlapping face recognition regions from non-overlapping regions or by generating a text, sound or voice warning. In an embodiment, a text warning indicates that two or more regions are adjacent or overlapping. In an embodiment, a voice or sound warning indicates that two or more regions are adjacent or overlapping. In an embodiment, when the face recognition regions are adjacent or overlap with each other, capturing may not be allowed. In FIG. 3A, face recognition regions 300, which are not adjacent or do not overlap with each other, and face recognition regions 310, which are adjacent or overlap with each other, are displayed differently (or separately). When the face recognition regions 310, which are adjacent or overlap with each other, are separately displayed or differentiated as shown in FIG. 3A or output as text or voice so as to change a capturing composition, the digital signal processor 50 determines that the face recognition regions are not adjacent or do not overlap with each other after guiding changing of a capturing composition and then, performs capturing. In an embodiment, emphasis is placed on the overlapping regions as compared to the non-overlapping regions. For example, as shown in FIG. 3A, the overlapping face recognition regions are bordered by a bolded, darker or thicker line than the non-overlapping regions. In addition, different colors or types of lines (for example a dotted or dashed line) may be used to differentiate the overlapping regions from the non-overlapping regions. Here, when the capturing composition is changed and the face recognition regions are not adjacent or do not overlap with each other, a shutter button (not illustrated) is pressed to capture an image or to automatically capture an image after a predetermined time. In FIG. 3B, the face recognition regions 310, which are adjacent or overlap with each other in FIG. 3A, are separately displayed or displayed in a way that differentiates them from non-overlapping regions and then, a composition is changed such that the faces are not adjacent or do not overlap with each other.

As such, since faces that are adjacent or overlap in images capturing a group of individuals are guided to change their composition such that the faces are not adjacent or do not overlap with each other and then, capturing is performed, an image with a better quality composition may be obtained than when capturing an image with adjacent or overlapping regions.

FIG. 4 is a block diagram of the digital signal processor 50 according to another embodiment included in the apparatus for capturing a digital image using the face recognition function of FIG. 1. The digital signal processor 50 includes the face recognition unit 51, the face recognition region display unit 53, the size determination unit 57, and the composition change guiding unit 59. The digital signal processor 50 of FIG. 4 guides changing of a capturing composition when the sizes of the face recognition regions are different from each other when capturing an image including a plurality of faces.

The face recognition unit 51 detects at least one face from an image including a group of people. The face recognition unit 51 is described in more detail above and thus a detailed description thereof will be omitted here.

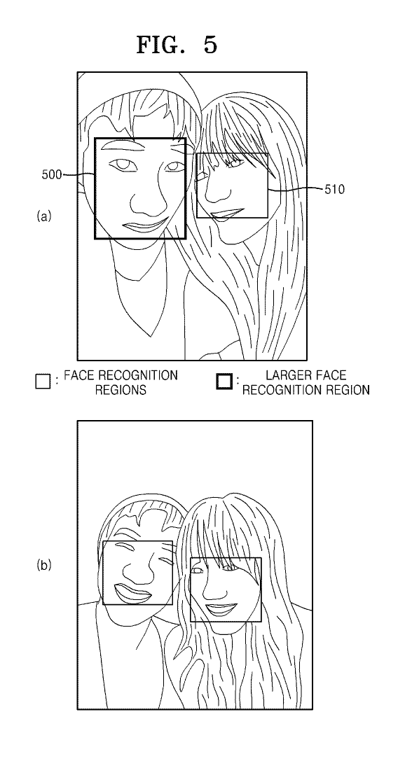

The face recognition region display unit 53 displays the face recognition regions over the recognized faces. In FIG. 5A, the face recognition regions are displayed according to the result of face recognition of an image including a plurality of people (for example, two people).

The size determination unit 57 calculates coordinate information about the face recognition regions, calculates the sizes of the face recognition regions, compares the sizes of the face recognition regions, and determines which of the face recognition regions is a larger face recognition region. Since the sizes of the face recognition regions are calculated using the coordinate information of each face recognition region, the calculated sizes are used to determine the larger face recognition region.

The composition change guiding unit 59 guides changing of a capturing composition, when a larger face recognition region exists, by separately displaying or differentiating the larger face recognition region from one or more smaller regions or by generating a text, sound or voice warning. In addition, when a larger face recognition region exists, capturing may not be allowed. In FIG. 5A, a larger face recognition region 500 and a smaller face recognition region 510 are displayed.

When the larger face recognition region 500 is separately displayed or differentiated from a smaller region or a text or voice indication that the face regions are not the same size is output, a change in a capturing composition results. The digital signal processor 50 allows capturing when the sizes of the face recognition regions are similar to each other, after guiding changing of a capturing composition. Here, when the capturing composition is changed and the sizes of the face recognition regions are similar to each other, a shutter button (not illustrated) is pressed to capture an image or to automatically capture an image after a predetermined time. In FIG. 5B, the larger face recognition region 500 and the smaller face recognition region 510 from FIG. 5A are separately displayed and then, a composition is changed such that the sizes of the faces are similar to each other.

Users do not want their faces to appear larger than the other people around them, so they step back from the other people while image capturing is being performed or they ask to re-capture an image if their faces are larger than the other people. However, as described above, since the sizes of the faces are not similar to each other when capturing a group of people, a capturing composition is guided to change such that the sizes of the faces are similar to each other and capturing is then performed, and thus, an image with a better composition than when the sizes vary significantly may be obtained.

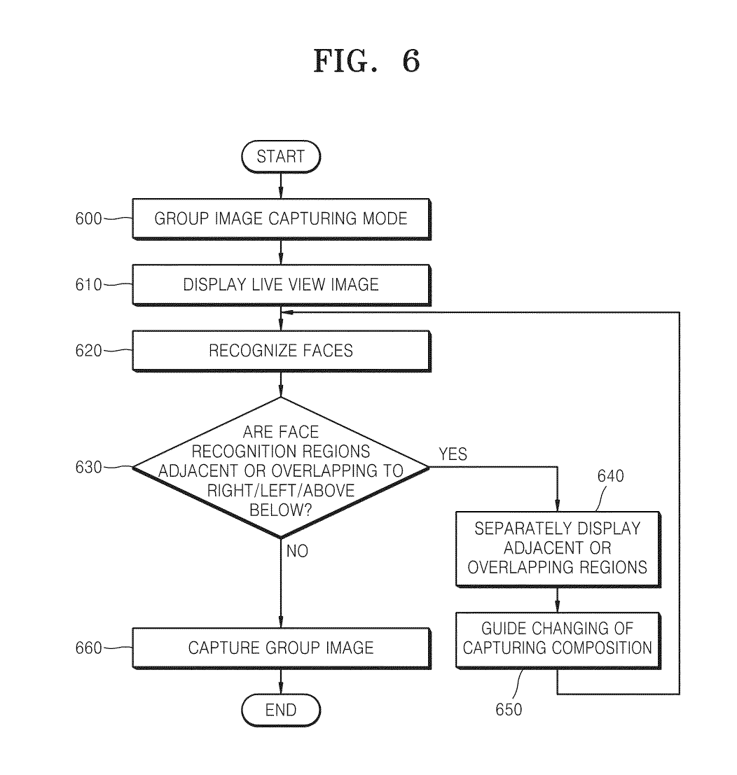

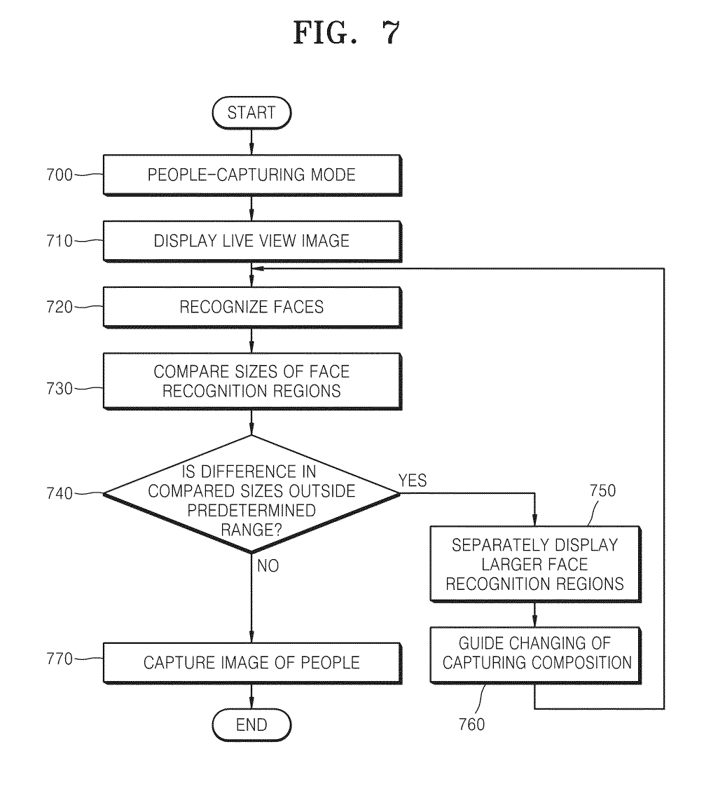

Hereinafter, methods of capturing a digital image by using a face recognition function in accordance with various embodiments are described in more detail with reference to FIGS. 6 and 7. The methods of capturing a digital image by using a face recognition function according to the embodiments may be performed in the apparatus for capturing a digital image as in FIGS. 1, 2, and 4 and a main algorithm of the methods may be performed in the digital signal processor 50 according to the above embodiments with support from other elements included in the apparatus.

First, a method of capturing a digital image using a face recognition function according to an embodiment is described with reference to FIG. 6. In FIG. 6, when the face recognition regions are adjacent or overlap with each other when capturing a group of individuals, a capturing composition is guided to be changed and then capturing is performed.

In operation 600, the digital signal processor 50, which receives a user input signal, allows the apparatus for capturing a digital image to enter a group image capturing mode.

In the group image capturing mode, the digital signal processor 50 displays a live view image on the display unit 80 in operation 610. FIG. 3 illustrates an example of the live view image for group image capturing.

When the live view image is displayed, the digital signal processor 50 recognizes faces from the live view image in operation 620. The digital signal processor 50 detects at least one face from the live view image including a group of people. The face recognition is described above and thus a detailed description thereof will be omitted here. In the current face recognition function, square face recognition regions are disposed over the faces of the subjects and the sizes of the face recognition regions increase or decrease according to the distance between the subjects and the lens 10.

After the face recognition, the digital signal processor 50 determines whether each of the face recognition regions are adjacent to the right/left/above/below or are overlapping in operation 630. The digital signal processor 50 calculates coordinate information about the face recognition regions for adjacency/overlap determination of the face recognition regions. Since the coordinate information about the face recognition regions is calculated, the coordinate information is used to determine adjacent face recognition regions or overlapping face recognition regions.

As a result of the determination, when the overlapping face recognition regions exist, the digital signal processor 50 separately displays the overlapping face recognition regions or differentiates the overlapping regions from the non-overlapping regions in operation 640, and guides changing of a capturing composition in operation 650. The digital signal processor 50 guides changing of the capturing composition, when the face recognition regions are adjacent or overlap with each other, by separately displaying or differentiating adjacent or overlapping face recognition regions or by generating a text, sound or voice warning. In an embodiment, when the face recognition regions are adjacent or overlap with each other, capturing may not be allowed.

After the capturing composition is guided to be changed, when the face recognition regions are not adjacent or do not overlap with each other, the digital signal processor 50 captures a group image in operation 660.

When the capturing composition is changed and the face recognition regions are not adjacent or do not overlap with each other, a shutter button (not illustrated) is pressed to capture an image or to automatically capture an image after a predetermined time.

In FIG. 3A, the face recognition regions 300, which are not adjacent or do not overlap with each other, and the face recognition regions 310, which are adjacent or overlap with each other, are displayed differently. In FIG. 3B, the face recognition regions 310, which are adjacent or overlap with each other in FIG. 3A, are separately displayed and then, the composition is changed such that the faces are not adjacent or do not overlap with each other. In an embodiment, whether a difference in size exists may be determined based on a difference in the width of two or more face regions or the height of two or more face regions or based on both the width and height of two or more face regions. In an embodiment, where a difference in size exists may be determined based on the difference between diagonals of two or more face regions or the areas of two or more face regions. In an embodiment, the sizes of two regions may be determined to be different only if the actual difference is greater than a predetermined value. In an embodiment, the predetermined value or amount may be zero or any other value or amount.

A method of capturing a digital image by using a face recognition function according to another embodiment is described with reference to FIG. 7. In FIG. 7, when the sizes of the face recognition regions are different from each other when capturing an image including a plurality of faces, a capturing composition is guided to be changed and then capturing is performed.

In operation 700, the digital signal processor 50, which receives a user input signal, allows the apparatus for capturing a digital image to enter a people-capturing mode.

In the people-capturing mode, the digital signal processor 50 displays a live view image on the display unit 80 in operation 710. FIG. 5 illustrates an example of the live view image for capturing an image of people.

When the live view image is displayed, the digital signal processor 50 recognizes faces from the live view image in operation 720. The digital signal processor 50 detects at least one face from the live view image including a group of people. The face recognition is described above and thus a detailed description thereof will be omitted here. In the current face recognition function, square face recognition regions are disposed over the faces of the subjects and the sizes of the face recognition regions increase or decrease according to the distance between the subjects and the lens 10.

After the face recognition, the digital signal processor 50 compares the sizes of the face recognition regions in operation 730, and determines whether the difference in the compared sizes is outside a predetermined range in operation 740. The digital signal processor 50 calculates coordinate information about the face recognition regions, calculates the sizes of the face recognition regions by using the coordinate information, compares the sizes of the face recognition regions, and determines whether the difference in the compared sizes is outside the predetermined range.

As a result of the determination, when larger face recognition regions, which are beyond the predetermined range, exist, the digital signal processor 50 separately displays the larger face recognition regions in operation 750 or differentiates the larger face recognition regions from the smaller ones or vice versa, and guides changing of a capturing composition in operation 760. In an embodiment, when larger face recognition regions exist, the digital signal processor 50 guides changing of the capturing composition by separately displaying the larger face recognition regions or by generating a text, sound or voice warning. In another embodiment, when larger face recognition regions exist, capturing may not be allowed to be performed.

After the capturing composition is guided to be changed, when the sizes of the face recognition regions are similar to each other, the digital signal processor 50 captures an image of the people in operation 770.

When the capturing composition is changed and the sizes of the face recognition regions are similar to each other, a shutter button (not illustrated) is pressed to capture an image or to automatically capture an image after a predetermined time.

In FIG. 5A, the face recognition regions are displayed according to the result of face recognition of an image including a plurality of people. In FIG. 5B, the larger face recognition region 500 and the smaller face recognition region 510 are separately displayed and then, the composition is changed such that the sizes of the faces are similar to each other.

As described above, the face recognition function according to an embodiment of the present invention is used so that faces do not overlap in group image capturing and to prevent a difference or a significant difference in the sizes of the faces when capturing an image of a plurality of faces, thereby obtaining a user desired image. The term “group” as used herein means more than one.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for capturing a digital image comprising:
a digital signal processing means for guiding a change in a capturing composition of the image when a first face region and a second face region are one of (i) adjacent to each other and (ii) overlap with each other.

2. The apparatus of claim 1, wherein the digital signal processing means automatically captures the image after a predetermined time passes after the change in the capturing composition and the first and second face regions are not one of (i) adjacent to each other and (ii) overlapping with each other.

3. The apparatus of claim 1, wherein the digital signal processing means comprises:
a face recognition unit recognizing a first face and a second face;
a face recognition region display unit displaying the first face region on the first face and the second face region on the second face;
an adjacency/overlap determination unit determining whether the first face region and the second face region are one of (i) adjacent to each other and (ii) overlap with each other; and
a composition change guiding unit guiding the change in the capturing composition when the first face region and second face region are one of (i) adjacent to each other and (ii) overlap with each other.

4. The apparatus of claim 1, wherein the digital signal processing means comprises:
an adjacency/overlap determination unit that calculates coordinate information about the first face region and coordinate information about the second face region and, by comparing the coordinate information of the first face region with the coordinate information of the second face region, determines whether the first face region and the second face region are one of (i) adjacent to each other and (ii) overlap with each other.

5. The apparatus of claim 3, wherein the composition change guiding unit guides the change in the capturing composition by one of (i) separately displaying adjacent face regions from non-adjacent face regions, (ii) separately displaying overlapping face regions from non-overlapping face regions, (iii) generating a text warning, (iv) generating a sound warning, and (v) generating a voice warning.

6. An apparatus for capturing a digital image comprising:
a digital signal processing means for guiding a change in a capturing composition when sizes of a first face region and a second face region differ from each other by more than a predetermined amount.

7. The apparatus of claim 6, wherein the digital signal processing means automatically captures the image after a predetermined time passes after the change in the capturing composition and the sizes of the first face region and second face region do not differ from each other by more than the predetermined amount.

8. The apparatus of claim 6, wherein the digital signal processing means comprises:
a face recognition unit recognizing a first face and a second face;
a face recognition region display unit displaying the first face region on the first face and the second face region on the second face;
a size determination unit determining the sizes of the first face region and the second face region; and
a composition change guiding unit guiding the change in the capturing composition when the sizes of the first and second face regions differ from each other by more than a predetermined amount.

9. The apparatus of claim 8, wherein the size determination unit calculates the size of the first face region from coordinate information about the first face region and calculates the size of the second face region from coordinate information about the second face region and determines which one of the first and second face regions is larger by comparing the sizes of the first and second face regions.

10. The apparatus of claim 8, wherein the composition change guiding unit guides the change in the capturing composition by one of (i) separately displaying a larger face region from a smaller face region, (ii) generating a text warning, (iii) generating a sound warning, and (iv) generating a voice warning.

11. The apparatus of claim 6 wherein the sizes of the first and second face regions are compared to each other based on one of: the areas of the first and second face regions, the heights of the first and second face regions, the widths of the first and second face regions and the diagonals of the first and second face regions.

12. A method of capturing a digital image comprising:
(a) recognizing faces in the image and displaying face regions on the recognized faces;
(b) determining whether the face regions are one of (i) adjacent to each other and (ii) overlap with each other; and
(c) guiding a change in a capturing composition of the image when the face regions are one of (i) adjacent to each other and (ii) overlap with each other.

13. The method of claim 12, further comprising:
(d) automatically capturing the image after a predetermined time passes after the change in the capturing composition and the face regions are not one of (i) adjacent to each other and (ii) overlapping with each other.

14. The method of claim 12, wherein (b) comprises:
(b-1) calculating coordinate information about the face regions; and
(b-2) comparing the coordinate information of an arbitrary face region with the coordinate information of a face region near the arbitrary face region and determining whether the two regions are one of (i) adjacent to each other and (ii) overlap with each other.

15. The method of claim 12, wherein in (c), the capturing composition is guided to be changed by one of (i) separately displaying adjacent face regions from non-adjacent face regions, (ii) separately displaying overlapping face regions from non-overlapping face regions, (iii) generating a text warning, (iv) generating a sound warning, and (v) generating a voice warning.

16. A method of capturing a digital image comprising:
(a) recognizing faces in the image and displaying face regions on the recognized faces;
(b) determining sizes of the face regions; and
(c) guiding changing of a capturing composition when the sizes of the face regions differ from each other by more than a predetermined amount.

17. The method of claim 16, further comprising:
(d) automatically capturing the image after a predetermined time passes after a change in the capturing composition and the sizes of the face regions do not differ from each other by more than the predetermined amount.

18. The method of claim 16, wherein (b) comprises:
(b-1) calculating coordinate information about the face regions;
(b-2) calculating the sizes of the face regions from the coordinate information; and
(b-3) comparing the sizes of the face regions and determining which face region is larger.

19. The method of claim 16, wherein in (c), the capturing composition is guided to be changed by one of (i) separately displaying a larger face region from a smaller face region, (ii) generating a text warning, (iii) generating a sound warning, and (iv) generating a voice warning.

20. The method of claim 16 wherein the sizes of the face regions are compared to each other based on one of: the areas of the face regions, the heights of the face regions, the widths of the face regions, and the diagonals of the face regions.
